(19) United States
(12) Patent Application Publication
(10) Pub. No.: US 2013/0022889 A1
(43) Pub. Date: Jan. 24, 2013

(54) FUEL CELL STACK

(71) Applicants: Tae-Ho KWON, Yongin-si (KR); Sang-Jun KONG, Yongin-si (KR); Kwang-Jin PARK, Yongin-si (KR); Duk-Hyoung YOON, Yongin-si (KR); Hyun SOH, Yongin-si (KR)

(72) Inventors: Tae-Ho KWON, Yongin-si (KR); Sang-Jun KONG, Yongin-si (KR); Kwang-Jin PARK, Yongin-si (KR); Duk-Hyoung YOON, Yongin-si (KR); Hyun SOH, Yongin-si (KR)

(73) Assignee: SAMSUNG SDI CO., LTD., Yongin-si (KR)

(21) Appl. No.: 13/285,609

(22) Filed: Oct. 31, 2011

Related U.S. Application Data
(60) Provisional application No. 61/510,647, filed on Jul. 22, 2011.

(51) Int. Cl. H01M 8/24

(52) U.S. Cl. 429/466

(57) ABSTRACT

Disclosed herein is a fuel cell stack in which the diameter of holes of a separator is formed larger than the diameter of respective unit cells, so that a plurality of unit cells may be easily coupled to the separator. The fuel cell stack may include a plurality of electrically connected unit cells, a separator having a plurality of holes corresponding to the plurality of unit cells. Each hole may have a diameter larger than a respective diameter of the unit cells, which allows one side of the unit cell to pass through the hole. The fuel cell stack may include a plurality of fixing members seated on the separator at one side of the unit cells and surrounding an outside of at least one unit cell. The fuel cell stack may include a sealing agent formed along the outside of the unit cell to close the holes. During operation, the fuel cell stack with the above configuration may prevent damage to the unit cells.

### CROSS-REFERENCE TO RELATED APPLICATIONS

This application claims priority to and the benefit of U.S. Provisional Application No. 61/510,647, filed on Jul. 22, 2011, the contents of which are hereby incorporated by reference in their entirety.

### BACKGROUND

1. Field

The embodiment relates to a fuel cell stack, and more particularly, to a fuel cell stack in which a plurality of unit cells may be easily coupled to a separator.

2. Description of the Related Technology

A solid oxide fuel cell (SOFC) operates at high temperature, e.g., 600 to 1000° C. The SOFC may have excellent efficiency and cause less pollution as compared with other types of fuel cells. Further, the SOFC may enable combined electricity generation and does not need a fuel reformer. The SOFC requires low voltage. Thus a plurality of unit cells is connected into a stack to obtain higher voltages. Here, the stack is constituted by inserting the plurality of unit cells into a plurality of holes formed in a separator.

### SUMMARY OF CERTAIN INVENTIVE ASPECTS

In one aspect, a fuel cell stack is provided in which the diameter of holes of a separator are formed to be larger than the diameter of respective unit cells, so that a plurality of unit cells are easily coupled to the separator.

In another aspect, a solid oxide fuel cell stack includes, for example, a plurality of unit cells, a current collector electrically connected to the plurality of unit cells, a separator plate having a plurality of holes a first end of each of the plurality of unit cells is positioned in one of the plurality of holes and a fixing member positioned around a perimeter of each of the plurality of unit cells and configured to seal each of the plurality of unit cells to the separator.

In some embodiments, the separator includes an edge portion and a through portion. In some embodiments, the plurality of holes is positioned in the through portion. In some embodiments, each of the plurality of holes includes a first hole diameter and a second hole diameter. In some embodiments, the first hole diameter and the second hole diameter are connected in a stepped portion. In some embodiments, the first hole diameter is smaller than the second diameter. In some embodiments, the fixing member is positioned within the second hole diameter. In some embodiments, each of the plurality of unit cells includes a first electrode, an electrolyte and a second electrode. In some embodiments, the solid oxide fuel cell stack further includes a sealing agent configured to seal the plurality of unit cells to the fixing member. In some embodiments, the fixing member is porous. In some embodiments, at least a portion of the sealing agent is positioned within the pores of the fixing member. In some embodiments, the sealing agent includes at least about 10,000 dPa·s. In some embodiments, the sealing agent includes about 10,000 dPa·s to about 12,000 dPa·s. In some embodiments, the fixing member is positioned on an upper surface of the separator plate and formed surrounding a perimeter of at least two of the plurality of unit cells. In some embodiments, the fixing member is formed of a foam or a mesh. In some embodiments, the fixing member is formed of a flexible material. In some embodiments, the fixing member includes a porosity of about 10 ppi to about 50 ppi.

In another aspect, a fuel cell stack is provided in which a fixing member is formed between a separator and a unit cell so that the unit cell is securely fixed to a separator and then sealed.

In another aspect, a fuel cell stack includes, for example, a plurality of unit cells electrically connected; a separator including a plurality of holes disposed in positions corresponding to the unit cells and having the diameter larger than the diameter of the unit cells, and allowing one side of the unit cells to pass through the holes; a plurality of fixing members seated on the separator at one side of the unit cells and surrounding an outside of at least one unit cell; and a sealing agent formed along the outside of the unit cell to close the holes.

In another aspect, a fuel cell stack is provided including a plurality of unit cells, which are easily coupled to a separator such that damage to the unit cells in operation of a fuel cell stack is prevented.

### BRIEF DESCRIPTION OF THE DRAWINGS

Features of the present disclosure will become more fully apparent from the following description and appended claims, taken in conjunction with the accompanying drawings. It will be understood these drawings depict only certain embodiments in accordance with the disclosure and, therefore, are not to be considered limiting of its scope; the disclosure will be described with additional specificity and detail through use of the accompanying drawings. An apparatus, system or method according to some of the described embodiments can have several aspects, no single one of which necessarily is solely responsible for the desirable attributes of the apparatus, system or method. After considering this discussion, and particularly after reading the section entitled “Detailed Description of Certain Inventive Embodiments” one will understand how illustrated features serve to explain certain principles of the present disclosure.

FIG. 1 is a perspective view of a conventional assembled fuel cell stack.

FIG. 2 an exploded perspective view illustrating a fuel cell stack according to an exemplary embodiment of the present disclosure.

FIG. 3 is a perspective view of the assembled fuel cell stack according to the exemplary embodiment of the present disclosure.

FIG. 4A is a photograph illustrating part of a fixing member.

FIG. 4B is another photograph illustrating part of the fixing member.

FIG. 5 is a cross-sectional view taken along line A-A′ of FIG. 3.

FIG. 6 is a perspective view of an assembled fuel cell stack according to another exemplary embodiment of the present disclosure.

FIG. 7 is an exploded perspective view illustrating a separator and a fixing member according to the other exemplary embodiment of the present disclosure.

FIG. 8 illustrates a major axis and a minor axis of a pore formed in a foam-shaped fixing member.

### DETAILED DESCRIPTION OF CERTAIN INVENTIVE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present disclosure. The drawings and description are to be regarded as illustrative in nature and not restrictive. However, it should be understood that the disclosure is not limited to a specific embodiment but includes all changes and equivalent arrangements and substitutions included in the spirit and scope of the disclosure. Descriptions of unnecessary parts or elements may be omitted for clarity and conciseness, and like reference numerals refer to like elements throughout. In the drawings, the size and thickness of layers and regions may be exaggerated for clarity and convenience.

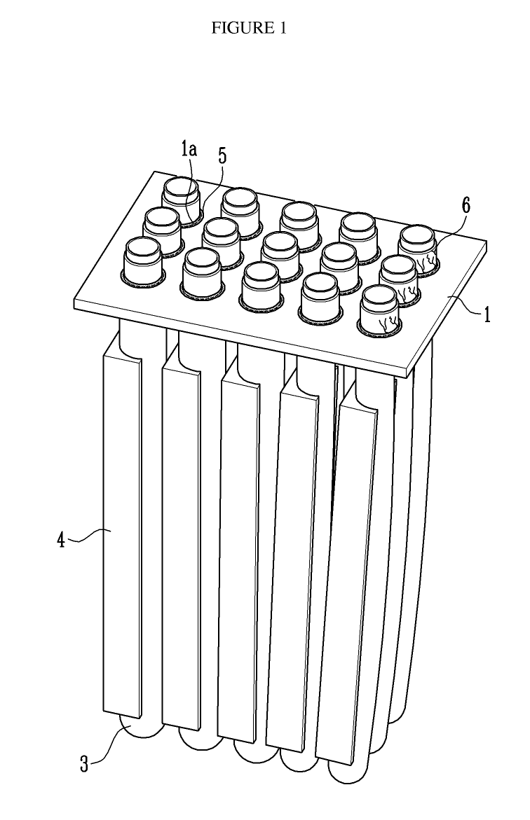

FIG. 1 is a perspective view of a conventional assembled fuel cell stack. Referring to FIG. 1, a solid oxide fuel cell (SOFC) generally employs a plurality of unit cells 3 connected into a stack in order to obtain high voltage. The stack is formed by coupling the unit cells 3 to a separator 1 having a plurality of holes 1a. Here, the unit cells 3 are electrically connected through a current collector 4.

The unit cells 3 are disposed at regular intervals by the current collector 4. The holes 1a of the separator 1 are formed in positions corresponding to the respective unit cells 3 based on the size of the unit cells 3 and the thickness of the current collector 4. Here, a gap allowance between the holes 1a and the unit cells 3 may be minimized for sealing. Here, the “size” of the holes 1a and the “size” of the unit cells 3 refer to the diameter of the holes 1a and the diameter of the unit cells 3 in a cylindrical fuel cell stack. However, when the stack is not a cylindrical shape, the size may denote, for example, a width of each unit cell in the cross section. For example, when four unit cells 3, two of which in each row are connected in series and two of which in each column are connected in parallel, defined as a 2S2P structure, are coupled to holes 1a of the separator 1, due to a relatively smaller number of unit cells 3, an error in corresponding positions of the holes 1a of the separator 1 to positions of the unit cells 3 hardly occurs in manufacture. That is, the unit cells 3 properly correspond in position to the holes 1a of the separator 1, so that the unit cells 3 are easily coupled to the separator 1.

However, when 15 unit cells 3, five of which in each row are connected in series and three of which in each column are connected in parallel, defined as a 5S3P structure, are coupled to holes 1a of the separator 1, shown in FIG. 1, an error may occur in manufacture due to a large number of unit cells 3. That is, the unit cells 3 do not properly correspond in position to the holes 1a of the separator 1, and thus it is difficult to couple the unit cells 3 to the separator 1.

Further, in a too small gap allowance between the holes 1a and the unit cells 3, when the unit cells 3 are inserted into the separator 1 and the holes 1a are sealed using a sealing agent 5, a crack 6 may occur in a coupled portion of the unit cells 3 and the separator 1 in temperature rise or a test drive. That is, the unit cells 3 may be bent, or be broken at end portions. Thus, in the fuel cell stack according to the present embodiment, there is a need to prevent damage in the coupled portion of the unit cells 3 and the separator 1.

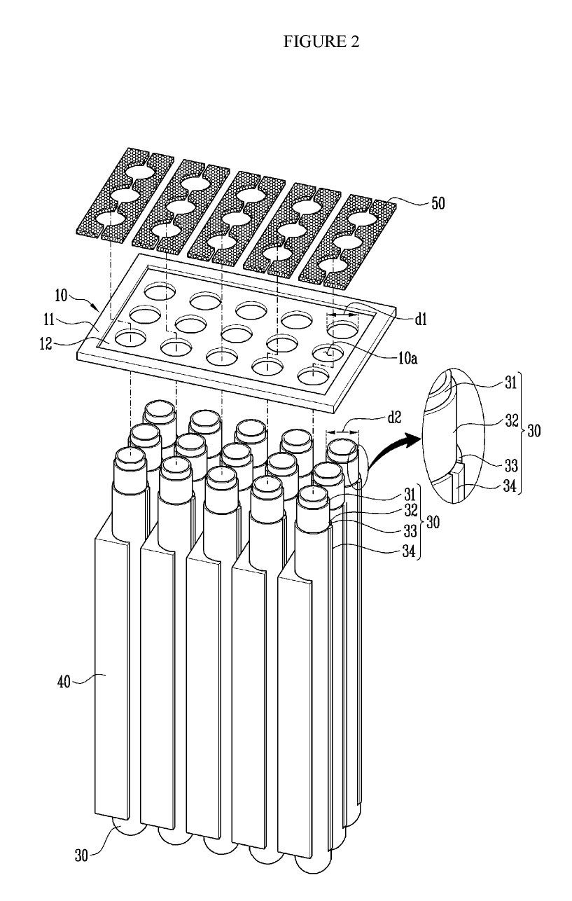

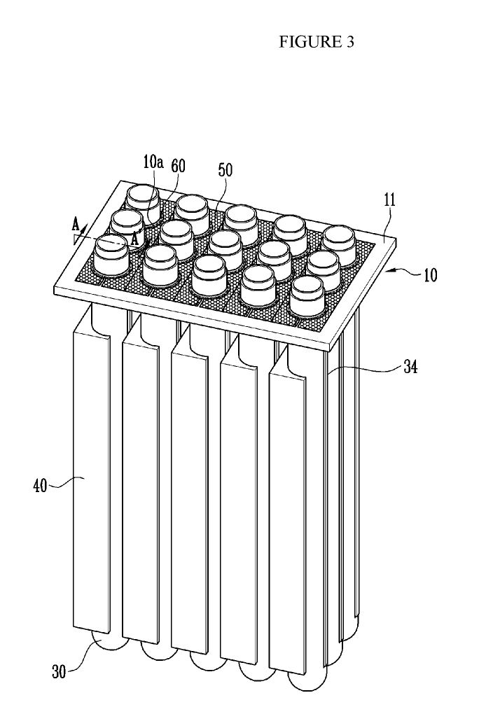

FIG. 2 is an exploded perspective view illustrating a fuel cell stack according an exemplary embodiment of the present disclosure. Referring to FIG. 2, the fuel cell stack includes a plurality of unit cells 30 electrically connected, a separator 10 including a plurality of holes 10a having a diameter larger than a diameter of the unit cells 30 and formed in positions corresponding to the unit cells 30, and a plurality of fixing members 50 and a sealing agent 60 (see FIG. 3) to fix the unit cells 30 to the separator 10.

A cylindrical anode-supported SOFC stack having the above configuration according to the present embodiment involves the following electrochemical reaction. Hydrogen provided through a through hole of a cylindrical unit cell 30 transfers electrons in a first electrode 31, which is an anode serving as a supporting member and electrode, and becomes hydrogen ions. The electrons in the first electrode 31 that is the anode transfer to a second electrode 33 that is a cathode of an adjacent unit cell 30 through a connecting member 34 and a current collector 40 (in a band shape) to ionize oxygen molecules. Then, oxygen ions transfer to the first electrode 31 that is the adjacent anode through an electrolyte 32 and react with the hydrogen ions to generate water, thereby completing the fuel cell reaction. The stacked unit cells 30 continuously perform the above reaction to generate electricity and heat.

That is, referring to one unit cell 30, fuel gas is provided to the first electrode 31 that is an inside part of the cylinder and the anode and air is provided to the second electrode 33 that is an outside part of the cylinder and the cathode to generate an electrochemical reaction, thereby obtaining voltage generated between the first electrode 31 and the second electrode 33, that is, the connecting member 34 and the second electrode 33.

Hereinafter, the components of the fuel cell stack are described in detail. First, 15 unit cells 30 are provided in a 5S3P structure and electrically connected by the current collector 40. Here, each unit cell 30 includes a tube-type first electrode 31 having a through hole, a connecting member 34 protruding and formed in a lengthwise direction on an outside of the first electrode 31, an electrolyte 32 formed on the outside of the first electrode 31 other than the connecting member 34, and a second electrode 33 formed on an outside of the electrolyte 32 so as not to be in contact with the connecting member 34. The unit cell 30 may have a sealed lower part.

In the present description, the first electrode 31 is referred to as the anode, and the second electrode 33 is referred to as the cathode. However, the first electrode 31 may be a cathode, and the second electrode 33 may be an anode.

The unit cells 30 are structurally supported and electrically connected by the current collector 40 simultaneously. The current collector 40 is disposed between adjacent unit cells 30 so that the unit cells 30 are disposed at regular intervals.

Referring to one row of three unit cells 30, one current collector 40 is simultaneously in contact with the cathodes 33 of the outside part of the three unit cells 30 to connect the unit cells 30 in parallel. The current collector 40 is in contact with the connecting member 34 connected to the cathodes of three unit cells 30 in another adjacent row and connects the unit cells 30 in series. As described above, the current collector 40 electrically connects a plurality of unit cells 30 in the 5S3P structure.

The separator 10 includes the plurality of holes 10a in corresponding positions to the unit cells 30. Here, the holes 10a may have the diameter d1 larger than the diameter d2 of the unit cells 30. Accordingly, when the unit cells 30 are coupled to the separator 10, one side of the unit cells 30 may smoothly pass through the holes 10a. The separator 10 includes an edge part 11 formed along an edge and a through part 12 formed inside the edge part 11 and including the holes 10a. Here, an upper surface of the separator 10 may be formed in a stepped shape so that the through part 12 is disposed lower than the edge part 11.

Further, the fixing members 50 are coupled to the through part 12 of the upper surface of the separator 10. Also, a plurality of fixing members 50 is provided in a shape to surround an outside of the unit cells 30. In the present embodiment, the fixing members 50 are formed to simultaneously surround the outside of a plurality of unit cells 30 disposed in one row. Here, the fixing members 50 may be separately formed to respectively surround one portion and the other portion of the outside of the unit cells 30. The fixing members 50 are formed in a foam or a mesh shape and serve to fix the unit cells 30 to the separator 10.

Although not shown in FIG. 2, the sealing agent 60 (FIG. 3) may be formed to close the holes 10a along the outside of the unit cells after the unit cells 30 are inserted into the holes 10a of the separator 10 and the fixing members 50 are coupled to the through part 12. The sealing agent 60 will be further described with reference to FIG. 3.

In the present embodiment, the diameter d1 of the holes 10a of the separator 10 is larger than the diameter d2 of the unit cells 30, which allows one sides of the unit cells 30 to easily pass through the holes 10a when the plurality of unit cells 30 are coupled to the separator 10. Thus, cracks on an end portion of the unit cells 30 may be prevented, whereas it is not easy to close the holes 10a only using the sealing agent 60 after the unit cells 30 are inserted into the holes 10a of the separator 10. That is, the sealing agent 60 may pass through the holes 10a and fall down from the separator 10. Thus, the fixing members 50 in the foam or mesh shape are coupled to the through part 12, and then the sealing agent 60 is applied along the outside of the unit cells 30, thereby easily closing the holes 10a.

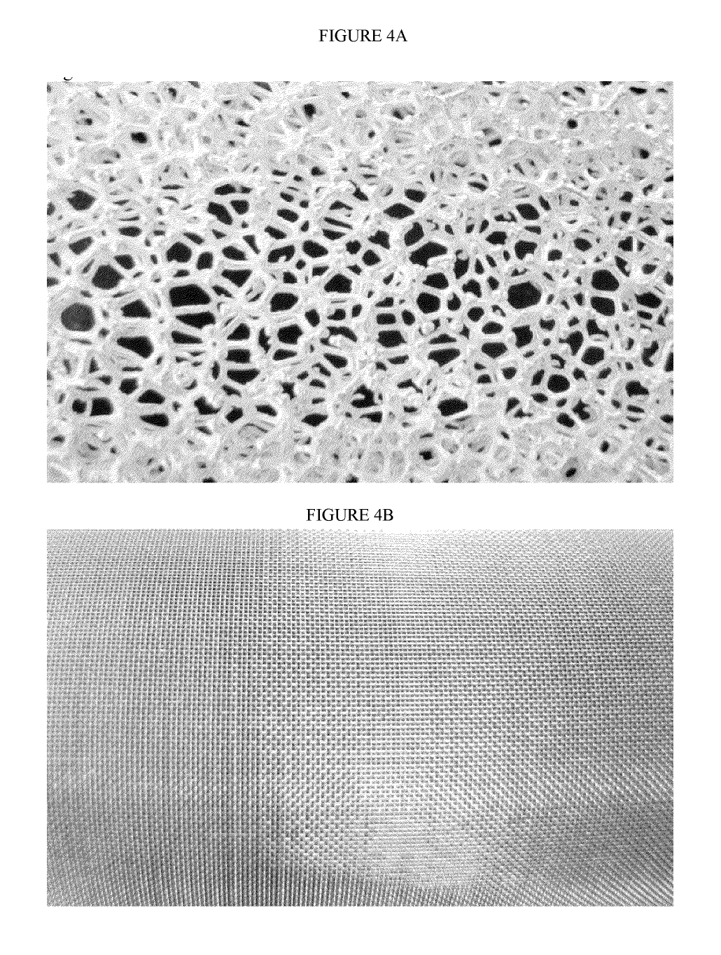

FIG. 3 is a perspective view of the assembled fuel cell stack according to the exemplary embodiment of the present disclosure, and FIG. 4A is a photograph illustrating part of the fixing members. Referring to FIGS. 3 and 4A, the unit cells 30 are coupled to the separator 10. That is, one side of each unit cell 30 passes through a hole 10a of the separator 10. Here, since the diameter of the holes 10a is larger than the diameter of the unit cells 30, the unit cells 30 may be easily inserted into the holes 10a of the separator 10 even if the intervals of the unit cells 30 are not uniform.

The fixing members 50 are formed to be disposed on the upper surface of the separator 10 and to simultaneously surround the outside of three unit cells 30 so that the three unit cells 30 are fixed to the separator 10. Further, the fixing members 50 may be separately formed to respectively surround one portion and the other portion of the outside of the plurality of unit cells 30.

The upper surface of the separator 10 to which the fixing members 50 are coupled may be formed in a stepped shape. That is, a portion of the upper surface where the fixing members 50 are coupled is formed to be lower than the other portion. In other words, the separator 10 includes the edge part 11 formed along the edge and the through part 12 (FIG. 2) formed inside the edge part 11 and including the holes 10a, and may be formed in a stepped shape so that the through part 12 is disposed lower than the edge part 11.

Accordingly, the fixing members 50 are coupled to the through part 12 of the separator 10 and fix the unit cells 30 to the separator 10. Here, the fixing members 50 may be formed of a soft metal, for example, nickel, and in a foam shape. The fixing members 50 have characteristics that the fixing members 50 are transformed in shape when a load is applied and the fixing members 50 are easily recovered when a load is eliminated. Thus, even if the unit cells 30 are not formed at regular intervals, the unit cells 30 may be easily fixed to the separator 10 using the fixing members 50 without causing an end portion of the unit cells to be broken.

Here, since the electrolyte 32 is exposed on the outside of the unit cells 30 which is in contact with the fixing members 50, the unit cells 30 may be insulated from the fixing members 50 of nickel.

With the unit cells 30 coupled to the separator 10 and the fixing members 50 formed, when the sealing agent 60 is formed along the outside of the unit cells 30 to close the holes 10a, thereby sealing an upper part and a lower part of the separator 10. Accordingly, fuel gas and air are prevented from mixing with each other and from leaking.

That is, referring to one unit cell 30, fuel gas is provided to the inside part of the cylinder that is the anode 31 and air is provided to the outside part of the cylinder that is the cathode 33. Accordingly, an electrochemical reaction is generated thereby obtaining voltage generated between the anode 31 and the cathode 33, that is, the connecting member 34 and the cathode 33. Here, a traveling path of the fuel gas is spatially separated from a traveling path of the air by the separator 10, and the fixing members 50 and the sealing agent 60 are formed on the holes 10a of the separator 10, thereby preventing the fuel gas and the air from mixing with each other.

Here, the fixing members 50 may be formed with pores at 10 ppi to 50 ppi. The unit “ppi,” which represents the size of the pores of the fixing members 50, denotes the number of pores per inch. In this example, the pores are formed at regular intervals.

When the pores of the fixing members 50 are formed at less than 10 ppi, it is difficult to insert the sealing agent 60 into the pores of the fixing members 50. When the pores of the fixing members 50 are formed at more than 50 ppi, the sealing agent 60 passes through the fixing members 50. That is, the sealing agent 60 does not close the holes 10a but passes though the holes 10a to fall down from the separator 10.

The size of the pores of the fixing members 50 in the foam shape may be measured using a microscope and an image analyzer. That is, the pores are observed with an optical microscope, and the lengths of the major axis and the minor axis of the observed pores are measured using the image analyzer (See FIG. 8). Then, the size of the pores is calculated by Equation 1. Here, at least 10 pores are used for measurement and the average lengths are calculated, thereby determining the lengths of the major axis and the minor axis of the pores.

Pore size (μm)=Major axis (a)*0.5Minor axis (b) Equation 1

Further, porosity may be measured using a fixing member sample in a certain size and a foam shape. That is, porosity may be calculated by Equation 2 after measuring the volume and mass of the fixing member sample. Here, the fixing member is formed of nickel, which has a density of 8.9 g/cm³.

Porosity (%)=100−100*(mass*1,000)/(volume*density of material) Equation 2

Further, the sealing agent 60 may have a viscosity of 10,000 dPa·s to 12,000 dPa·s. When the viscosity of the sealing agent 60 is less than 10,000 dPa·s, it is difficult to seal a gap between the outside of the unit cells 30 and the holes 10a of the separator 10, and the sealing agent 60 may pass through the pores of the fixing members 50 to fall down from the separator 10. When the viscosity of the sealing agent 60 is more than 12,000 dPa·s, the sealing agent 60 may not fill the pores of the fixing members 50. Accordingly, the sealing agent 60 may be deposited only on the surface of the fixing members 50, thereby reducing sealing performance in the gap between the outside of the unit cells 30 and the holes 10a of the separator 10. Thus, considering the fuel cell stack operating at 600° C. to 1,000° C., the sealing agent 60 may have a viscosity of 10,000 dPa·s to 12,000 dPa·s.

Here, when the pores of the fixing members 50 are at greater than 50 ppi, it may be difficult for the sealing agent 60 to fill the holes 10a of the fixing members 50 since a great number of holes are formed in the fixing members 50 despite application of the sealing agent 60 having a viscosity of 10,000 to 12,000 dPa·s. Also, when the pores of the fixing members 50 are formed at less than 10 ppi, the sealing agent 60 may pass through the holes 10a to fall down from the separator 10 despite application of the sealing agent 60 having a viscosity of 10,000 dPa·s to 12,000 dPa·s.

FIG. 4B is another photograph illustrating part of the fixing members. FIG. 4A shows the fixing members 50 in the foam shape, while FIG. 4B shows the fixing members 50 in a mesh shape. Mesh is arranged in which a plurality horizontal lines and longitudinal lines are crossed and space being composed of the horizontal lines and longitudinal lines is approximately to be square.

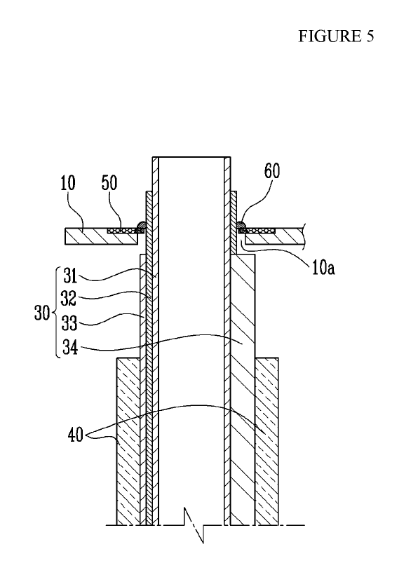

FIG. 5 is a cross-sectional view taken along line A-A′ of FIG. 3. Referring to one unit 30 coupled to a hole 10a of the separator 10, shown in FIG. 5, since the diameter of the hole 10a is larger than the diameter of the unit cell 30, the unit cell 30 easily passes through the hole 10a. Further, a fixing member 50 disposed on the upper surface of the separator 10 blocks the hole 10a to a certain degree and fixes the separator 10 to the unit cell 30. Also, the sealing agent 60 formed along the outside of the unit cell 30 to close the hole 10a may thoroughly seal the upper part and the lower part of the separator 10.

As described above, the diameter of the hole 10a of the separator 10 is formed to be larger than the diameter of the unit cell 30, thereby easily coupling the unit cell 30 to the separator 10 and preventing damage to the unit cell 30 in operation of the fuel cell stack. In addition, the fixing member 50 is formed and sealed between the separator 10 and the unit cell 30 to seal the upper part and the lower part of the separator 10 so that the fuel cell and air do not mix with each other or not leak.

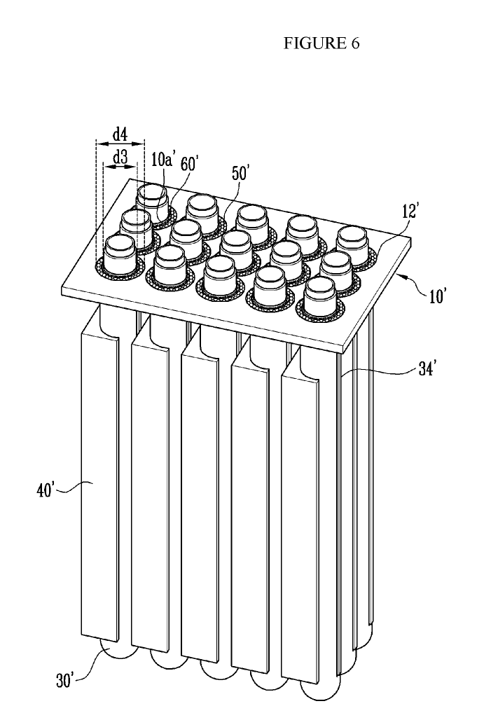

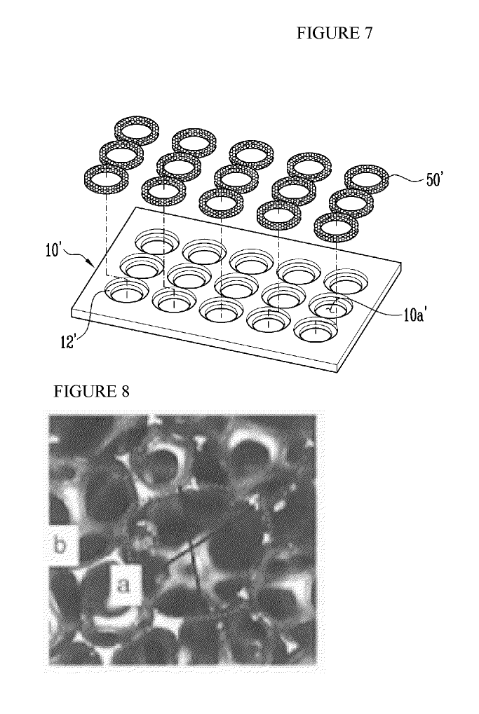

FIG. 6 is a perspective view of an assembled fuel cell stack according to another exemplary embodiment of the present disclosure, and FIG. 7 is an exploded perspective view illustrating a separator and a fixing member according to the other exemplary embodiment of the present disclosure. Referring to FIGS. 6 and 7, the fuel cell stack according to the present embodiment includes a plurality of unit cells 30′ electrically connected, and a separator 10′ including a plurality of holes 10a′ formed in corresponding positions to the unit cells 30′ and allowing one side of the unit cells 30′ to pass through the holes 10a′. The fuel cell stack also includes a plurality of fixing members 50′ coupled to the separator 10′ at one side of the unit cells 30′ and surrounding an outside of the respective unit cells 30′. In addition, the fuel cell stack further includes a sealing agent 60′ closing the holes 10a′ along the outside of the unit cells 30′. In the description of the present embodiment with reference to FIG. 6, the same components as in the above embodiment are not repeatedly described.

In the present embodiment, the respective fixing members 50′ may be formed in a ring shape to surround the outside of one unit cell 30′. An upper surface of the separator 10′ to which the fixing members 50′ are coupled may be formed in a stepped shape so that the fixing members 50′ are easily fixed. That is, a fixing portion 12′ of the upper surface of the separator 10′ where the ring-shaped fixing members 50′ are coupled is formed to be lower than the other portion.

The diameter d3 of an inner circumferential part of the ring-shaped fixing members 50′ may be formed to be the same as or smaller than the diameter of the outside of the unit cells 30′. The diameter d4 of an outer circumferential part of the ring-shaped fixing members 50′ may be formed to be larger than the diameter of the holes 10a′ of the separator 10′. Since the fixing members 50′ are formed in a foam or mesh shape of a soft material, the unit cells 30′ are easily fixed to the fixing members 12′ of the separator 10′ at one side even if the diameter d3 of the inner circumferential part of the ring-shaped fixing members 50′ is smaller than the diameter of the outside of the unit cells 30′. Accordingly, the fixing members 50′ may block the holes 10a′ of the separator 10′ and simultaneously couple the unit cells 30′ to the separator 10′.

Since the ring-shaped fixing members 50′ respectively fix the unit cells 30′ to the separator 10′, the unit cells 30′ are easily fixed to the separator 10′ even if intervals of the unit cells 30′ are not uniform. Also, after forming the ring-shaped fixing members 50′, the sealing agent 60′ is formed along the outside of the unit cells 30′ to close the holes 10a′, thereby preventing fuel gas and air from mixing with each other or from leaking.

FIG. 8 illustrates a major axis and a minor axis of a pore formed in a foam-shaped fixing member.

While the present invention has been described in connection with certain exemplary embodiments, it will be appreciated by those skilled in the art that various modifications and changes may be made without departing from the scope of the present disclosure. The drawings and the detailed description of certain inventive embodiments given so far are only illustrative, and they are only used to describe certain inventive embodiments, but are should not used be considered to limit the meaning or restrict the range of the present invention described in the claims. Indeed, it will also be appreciated by those of skill in the art that parts included in one embodiment are interchangeable with other embodiments; one or more parts from a depicted embodiment can be included with other depicted embodiments in any combination. For example, any of the various components described herein and/or depicted in the Figures may be combined, interchanged or excluded from other embodiments. With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity. Therefore, it will be appreciated to those skilled in the art that various modifications may be made and other equivalent embodiments are available. Accordingly, the actual scope of the present invention must be determined by the spirit of the appended claims, and equivalents thereof.

What is claimed is:

1. A solid oxide fuel cell stack, comprising:
a plurality of unit cells;
a current collector electrically connected to the plurality of unit cells;
a separator plate having a plurality of holes a first end of each of the plurality of unit cells is positioned in one of the holes; and
a fixing member positioned around a perimeter of each of the unit cells and configured to seal each of the unit cells to the separator.

2. The solid oxide fuel cell stack of claim 1, wherein the separator comprises an edge portion and a through portion.

3. The solid oxide fuel cell stack of claim 2, wherein the plurality of holes is positioned in the through portion.

4. The solid oxide fuel cell stack of claim 1, wherein each of the holes has a first hole diameter and a second hole diameter, wherein the first hole diameter and the second hole diameter are connected in a stepped portion, and wherein the first hole diameter is smaller than the second diameter.

5. The solid oxide fuel cell stack of claim 4, wherein the fixing member is positioned within the second hole diameter.

6. The solid oxide fuel cell stack of claim 1, wherein each of the unit cells comprises a first electrode, an electrolyte and a second electrode.

7. The solid oxide fuel cell stack of claim 1 further comprising a sealing agent configured to seal the unit cells to the fixing member.

8. The solid oxide fuel cell stack of claim 7, wherein the fixing member is porous.

9. The solid oxide fuel cell stack of claim 8, wherein at least a portion of the sealing agent is positioned within the pores of the fixing member.

10. The solid oxide fuel cell stack of claim 7, wherein the sealing agent comprises at least about 10,000 dPa·s.

11. The solid oxide fuel cell stack of claim 7, wherein the sealing agent comprises about 10,000 dPa·s to about 12,000 dPa·s.

12. The solid oxide fuel cell stack of claim 1, wherein the fixing member is positioned on an upper surface of the separator plate and formed by or formed to surround a perimeter of at least two of the unit cells.

13. The solid oxide fuel cell stack of claim 1, wherein the fixing member is formed of a foam or a mesh.

14. The solid oxide fuel cell stack of claim 1, wherein the fixing member is formed of a flexible material.

15. The solid oxide fuel cell stack of claim 1, wherein the fixing member comprises a porosity of about 10 ppi to about 50 ppi.
